(19) United States
(12) Patent Application Publication
(10) Pub. No.: US 2026/0075692 A1
(43) Pub. Date: Mar. 12, 2026

(54) LED POWER SUPPLY CONTROL SYSTEM

(71) Applicant: Jiangmen Qinjian Semiconductor Technology Co., Ltd, Jiangmen (CN)

(72) Inventor: Zhaowei Zhen, Jiangmen (CN)

(21) Appl. No.: 19/324,233

(22) Filed: Sep. 10, 2025

(30) Foreign Application Priority Data
Jul. 10, 2024 (CN) 202410922486.8

(51) Int. Cl. H05B 47/17; H05B 45/375

(52) U.S. Cl. CPC H05B 47/17; H05B 45/375

(57) ABSTRACT

An LED power supply control system includes a plurality of LED power supply control apparatuses. Each LED power supply control apparatus includes a switch module, a power processing module, a main power supply module, and a control module. The plurality of LED power supply control apparatuses are grouped and each group is configured with a same cyclic bit period and a same online bit period that differs from online bit periods of other groups, to control the switch module during both a startup mode and an operation mode and enable the control module to switch between power supply from the main power supply module and power supply from the external input power.

### CROSS-REFERENCE TO RELATED APPLICATION

The present application claims priority to Chinese Patent Application No. 202410922486.8, filed with the China National Intellectual Property Administration on Jul. 10, 2024 and entitled “LED POWER SUPPLY CONTROL SYSTEM”, which is incorporated herein by reference in its entirety.

### TECHNICAL FIELD

The present disclosure relates to the technical field of semiconductor devices, and in particular, to a light-emitting diode (LED) power supply control system.

### BACKGROUND

An LED is a semiconductor device capable of efficiently converting electrical energy into light energy. LEDs offer energy-saving and environmental benefits and therefore gain wide popularity among consumers. In addition, LED drive circuits with signal control enable LEDs to achieve more color variations and lighting modes, leading to broad application in the field of decorative lighting. For example, LED strips, LED bulbs, and floodlights can create rich and diverse lighting effects, enhancing the aesthetics and artistic ambiance of a space.

LED control technology has advanced significantly in recent years, but such developments primarily focus on signal control. In terms of power supply control, a suitable power source is configured based on the voltage of each LED. The power supply circuit is simple, and the control method is single, making it unable to adapt to multi-scenario applications. For example, if the operating voltage of an LED is 3 V, a maximum of only eight LEDs can be connected in series in a circuit with a 24 V power source, preventing the connection of more LEDs.

Furthermore, when increasing the quantity of LEDs, a higher voltage needs to be configured, correspondingly increasing energy consumption. For example, if the operating voltage of each LED is 3 V and the operating current is 10 mA, connecting 12 LEDs in series require a power supply with a voltage of 36 V and a current of 10 mA, resulting in significant resource consumption.

Therefore, resolving the technical problems of simplistic LED power supply circuits, single control methods, inability to adapt to multi-scenario applications, and high energy consumption when numerous LEDs are used has become an urgent issue for those skilled in the art to address.

### SUMMARY

The present disclosure provides an LED power supply control system, to address the technical problems of simplistic LED power supply circuits, single control methods, inability to adapt to multi-scenario applications, and high energy consumption when numerous LEDs are used. The solution achieves multi-mode control of LEDs, drives a greater number of LED lights with the same voltage, reduces power consumption, and improves energy utilization efficiency.

To address the above technical problems, an example of the present disclosure provides an LED power supply control system, including: a plurality of LED power supply control apparatuses, where each of the LED power supply control apparatuses includes a switch module, a power processing module, a main power supply module, and a control module; the main power supply module includes a charging module; and
each of the LED power supply control apparatuses is configured to:
during a startup mode, control the corresponding switch module to be in an online state, process received external input power through the corresponding power processing module, and use the processed external input power to supply power to the corresponding control module, to start the corresponding control module;
count, through the started control module, bit periods of a first control signal received by the respective control module, and generate, through the respective control module based on the counted bit periods, a second control signal for enabling control of the corresponding switch modules group-by-group to actuate, such that the corresponding external input power meets a voltage threshold and a current threshold required for driving an LED to operate, thereby entering an operation mode; and
during the operation mode, control, through the respective control module and based on the second control signal, the corresponding switch module to actuate, such that the corresponding control module switches between different power supply modes, where the power supply modes include power supply from the charging module and power supply from the external input power.

In some examples, the startup mode may occur on condition that the external input power does not meet the voltage threshold or the current threshold required for driving the LED to operate; and
the operation mode may occur on condition that the external input power meets the voltage threshold and the current threshold required for driving the LED to operate, and the charging module is activated and charged.

In some examples, the main power supply module may further include a power detection module configured to:
during the operation mode, detect whether power of the charging module meets the voltage threshold and the current threshold required for driving the LED to operate; and
determining that the power of the charging module that is detected during the operation mode does not meet the voltage threshold and the current threshold required for driving the LED to operate, generate a third control signal to control the switch module to be in the online state, where
the third control signal has a higher priority than the second control signal.

In some examples, the control module may include a positive connection terminal, a negative connection terminal, and a control signal output terminal; in each of the LED power supply control apparatuses, a first contact of the switch module may be connected to a positive pole of the external input power, and a second contact of the switch module may be connected to an input terminal of the power processing module and an input terminal of the main power supply module, respectively; a first output terminal of the main power supply module and a first output terminal of the power processing module may both be connected to the positive connection terminal of the control module;
a second output terminal of the main power supply module, a second output terminal of the power processing module, and the negative connection terminal of the control module may all be connected to a negative pole of the external input power;
the positive connection terminal of the control module may be further configured to be connected to a positive pole of the LED, and the negative pole of the external input power may be further connected to a negative pole of the LED; and
the control signal output terminal of the control module may be connected to a controlled terminal of the switch module.

In some examples, the first control signal may be an internal control signal.

In some examples, the first control signal may be an external control signal;
the corresponding control module may further include a decoding module and a driving module;
the decoding module may be configured to decode the external control signal to obtain bit period data; and
the driving module may be configured to drive the LED to operate.

In some examples, the external control signal may be transmitted in a form of an independent signal or a carrier signal;
the carrier signal may be a signal transmitted based on the external input power; and
a data bit 0 and a data bit 1 corresponding to the carrier signal have same duration, and the data bit 0 and the data bit 1 may have same high-level duration.

The same high-level duration ensures that when the switch module is in the online state, the control module receives adequate power support regardless of whether receiving a data bit 0 signal or a data bit 1 signal.

In some examples, the LED power supply control apparatuses may be grouped into a plurality of groups, and the control modules in each group may be preset with a same online bit period that differs from online bit periods of other groups;
wherein, generate, through the respective control module based on the counted bit periods, the second control signal for enabling control of the corresponding switch modules group-by-group to actuate, may comprise that each of the LED power supply control apparatuses is specifically configured to:
on condition that the counted bit period matches the corresponding online bit period, generate, through the respective control module, the second control signal for controlling the switch module to be in the online state; or
on condition that the counted bit period does not match the corresponding online bit period, generate, through the respective control module, the second control signal for controlling the switch module to be in an offline state such that the corresponding LED power supply control apparatus is unable to receive the external input power; and
wherein, control, through the respective control module and based on the second control signal, the corresponding switch module to actuate, such that the corresponding control module switches between different power supply modes, may comprise that each of the LED power supply control apparatuses is specifically configured to:
control, through the respective control module and based on the second control signal, the switch module to switch between the online state and the offline state, where
on condition that the switch module is in the online state, the external input power supplies power to the corresponding control module and the LED, and charges the corresponding charging module; or
on condition that the switch module is in the offline state, the corresponding charging module supplies power to the corresponding control module and the LED.

In some examples, the LED power supply control apparatuses may be grouped into a plurality of groups, and the control modules in each of the groups may be preset with a same online bit period that differs from online bit periods of other groups; the LED power supply control apparatuses may be connected in series, and the corresponding switch module may include a first contact, a second contact, and a third contact, the first contact of the switch module may be connected to a positive pole of the external input power, and the second contact of the switch module may be connected to an input terminal of the power processing module and an input terminal of the main power supply module, respectively; and the third contact may be connected to a second output terminal of the power processing module, to a second output terminal of the main power supply module, and to a negative pole of the external input power;
on condition that the switch module is in an offline state, the corresponding first contact may be connected to the third contact;
a quantity of LED power supply control apparatuses in each group may be calculated by using a first formula; and
the first formula may be:

$$N \leq \frac{V}{{V}_{q}}$$

where, N represents the quantity of LED power supply control apparatuses in each of the groups, V represents a voltage of the external input power, and V_{q} represents the voltage threshold; and
wherein, process the received external input power through the corresponding power processing module, may comprise that each of the LED power supply control apparatuses is specifically configured to:
perform a boost conversion on the received external input power through the corresponding power processing module.

In some examples, the LED power supply control apparatuses may be grouped into a plurality of groups, and the control modules in each group may be preset with a same online bit period that differs from online bit periods of other groups; the LED power supply control apparatuses may be connected in parallel;
a quantity of LED power supply control apparatuses in each of the groups may be calculated by using a second formula; and
the second formula may be:

$$N \leq \frac{I}{{I}_{q}}$$

where, N represents the quantity of LED power supply control apparatuses in each of the groups, I represents a current of the external input power, and I_{q} represents the current threshold; and
wherein, process the received external input power through the corresponding power processing module, may comprise that each of the LED power supply control apparatuses is specifically configured to:
perform a buck conversion on the received external input power through the corresponding power processing module.

Compared with the prior art, the LED power supply control system provided in the examples of the present disclosure exhibits at least one of the following beneficial effects:
(1) The present disclosure offers diverse control modes, enables connecting a greater number of LEDs in series under the same voltage, and adapts to more application scenarios.
(2) When increasing the number of LEDs, there is no need for configuring a power source with a higher voltage, thereby reducing power consumption, conserving energy, and improving energy utilization efficiency.

### BRIEF DESCRIPTION OF THE DRAWINGS

FIG. 1 is a schematic structural diagram of an LED power supply control apparatus according to an example of the present disclosure;

FIG. 2 is a schematic structural diagram of an LED power supply control apparatus in which a first control signal is an independent signal, according to an example of the present disclosure;

FIG. 3 is a schematic structural diagram of an LED power supply control apparatus in which a first control signal is a carrier signal, according to an example of the present disclosure;

FIG. 4 is a schematic structural diagram of an LED power supply control system in which LED power supply control apparatuses are connected in series and a first control signal is a series-independent signal, according to an example of the present disclosure;

FIG. 5 is a schematic structural diagram of an LED power supply control system in which LED power supply control apparatuses are connected in series and a first control signal is a parallel-independent signal, according to an example of the present disclosure;

FIG. 6 is a schematic structural diagram of an LED power supply control system in which LED power supply control apparatuses are connected in parallel and a first control signal is a series-independent signal, according to an example of the present disclosure;

FIG. 7 is a schematic structural diagram of an LED power supply control system in which LED power supply control apparatuses are connected in parallel and a first control signal is a parallel-independent signal, according to an example of the present disclosure;

FIG. 8 is a schematic diagram illustrating a data bit 0 and a data bit 1 when an external control signal is a carrier signal according to an example of the present disclosure;

FIG. 9 is a schematic structural diagram of an LED power supply control system in which LED power supply control apparatuses are connected in series and a first control signal is an internal control signal, according to an example of the present disclosure;

FIG. 10 is a schematic structural diagram of an LED power supply control system in which LED power supply control apparatuses are connected in series and a first control signal is a carrier signal, according to an example of the present disclosure;

FIG. 11 is a schematic structural diagram of an LED power supply control apparatus in which a switch module includes a third contact, according to an example of the present disclosure;

FIG. 12 is a schematic structural diagram of an LED power supply control system in which LED power supply control apparatuses are connected in parallel and a first control signal is an internal control signal, according to an example of the present disclosure;

FIG. 13 is a schematic structural diagram of an LED power supply control system in which LED power supply control apparatuses are connected in parallel and a first control signal is a carrier signal, according to an example of the present disclosure;

FIG. 14 is a schematic structural diagram of a control module according to an example of the present disclosure; and

FIG. 15 is a schematic structural diagram of a main power supply module according to an example of the present disclosure.

### REFERENCE NUMERALS

1: LED power supply control apparatus; 11: switch module; 12: power processing module; 13: charging module; 14: main power supply module; 15: control module; 16: signal detection module.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. Rather, these embodiments are provided to make the content of the present disclosure understood thoroughly and comprehensively. All other embodiments obtained by a person of ordinary skill in the art based on the embodiments of the present disclosure without creative efforts should fall within the protection scope of the present disclosure.

In the description of the present disclosure, the terms such as “first”, “second” and “third” are only for the purpose of description and should not be construed as indicating or implying relative importance, or implicitly indicating a quantity of indicated technical features. Thus, features defined with “first”, “second” and “third” may explicitly or implicitly include one or more of the features. In addition, in the description of the present disclosure, unless otherwise specified, “a plurality of” means at least two.

In the description of the present disclosure, it should be noted that, unless otherwise clearly specified, meanings of terms “install”, “connected with”, and “connected to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two components. The terms “vertical”, “horizontal”, “left”, “right”, “upper”, “lower” and similar expressions used herein are merely for the purpose of illustration, and do not indicate or imply that the referred device or element must have a specific orientation or be constructed and operated in a specific orientation, therefore these terms cannot be understood as limitation to the present disclosure. The term “and/or” used herein includes any and all combinations of one or more related items listed. A person of ordinary skill in the art may understand specific meanings of the foregoing terms in the present disclosure based on a specific situation.

In the description of the present disclosure, it should be noted that unless otherwise defined, all technical and scientific terms used herein have the same meaning as commonly understood by those skilled in the technical field of the present disclosure. The terms used in the description of the present disclosure are for the purpose of describing particular embodiments only and are not intended to be limiting of the present disclosure. Those of ordinary skill in the art should understand the specific meanings of the above terms in the present disclosure based on specific situations.

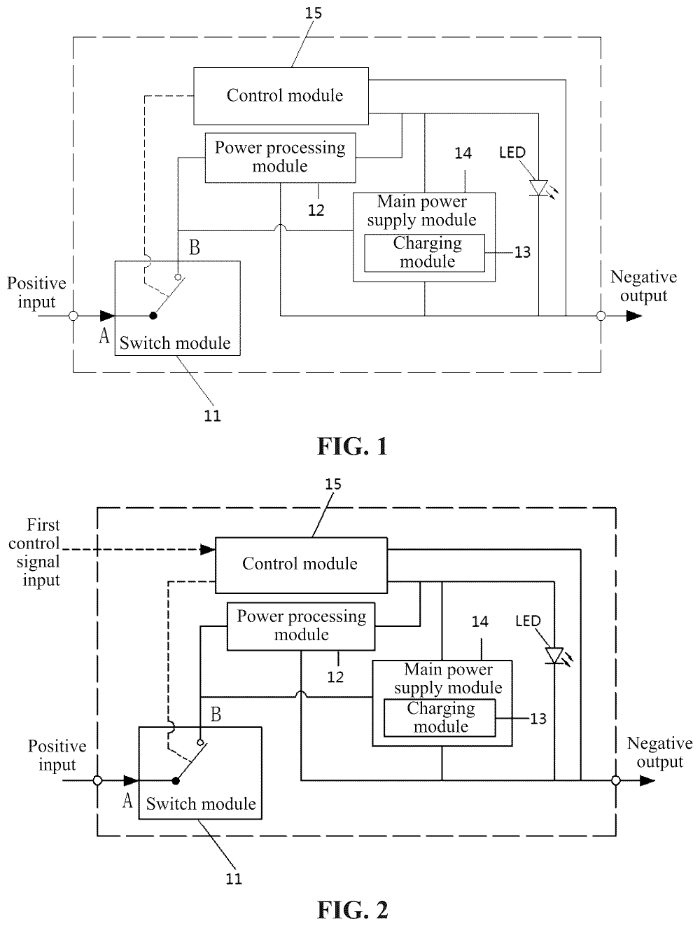

An example of the present disclosure provides an LED power supply control system, including: a plurality of LED power supply control apparatuses 1. Each LED power supply control apparatus 1 includes a switch module 11, a power processing module 12, a main power supply module 14, and a control module 15. The main power supply module 14 includes a charging module 13, and the control module 15 includes a bit period counting module. FIG. 1 is a schematic structural diagram of an LED power supply control apparatus according to an example of the present disclosure. The control module 15 includes a positive connection terminal, a negative connection terminal, and a control signal output terminal. In each LED power supply control apparatus 1, a first contact A of the switch module 11 is connected to a positive pole of an external input power, and a second contact B of the switch module 11 is connected to an input terminal of the power processing module 12 and an input terminal of the main power supply module 14, respectively.

A first output terminal of the main power supply module 14 and a first output terminal of the power processing module 12 are both connected to the positive connection terminal of the control module 15.

A second output terminal of the main power supply module 14, a second output terminal of the power processing module 12, and the negative connection terminal of the control module 15 are all connected to a negative pole of the external input power.

The positive connection terminal of the control module is further configured to be connected to a positive pole of an LED, and the negative pole of the external input power is further connected to a negative pole of the LED.

The control signal output terminal of the control module 15 is connected to a controlled terminal of the switch module 11.

Each LED power supply control apparatus 1 is configured to:
during a startup mode, control the corresponding switch module 11 to be in an online state, process received external input power through the corresponding power processing module 12, and use the processed external input power to supply power to the corresponding control module 15, to enable start up of the corresponding control module 15.

In an example of the present disclosure, the state of the switch module 11 includes an online state and an offline state. The online state is defined as a state in which the external input power can supply power to the corresponding power processing module 12 and the corresponding main power supply module 14 through the corresponding switch module 11, and the power processing module 12 and the main power supply module 14 can receive the external input power. The offline state is defined as a state in which the external input power cannot supply power to the corresponding power processing module 12 and the corresponding main power supply module 14 through the corresponding switch module 11, and the power processing module 12 and the main power supply module 14 cannot receive the external input power. In practical applications, the switch module 11 is, for example, a switch. The contact of the switch module 11 is a contact of the switch, and the controlled terminal of the switch module 11 is a controlled terminal of the switch. When the first contact A of the switch module 11 is connected to the second contact B, the switch module 11 is in the online state; and when the first contact A of the switch module 11 is disconnected from the second contact B, the switch module 11 is in the offline state.

Each started control module 15 counts bit periods of a received first control signal. The control module 15 generates a second control signal based on the counted bit periods, to control the switch modules 11 group-by-group to actuate. In this process, only the switch modules 11 of a portion of the LED power supply control apparatuses 1 are in the online state during each bit period, enabling adjustment of the voltage or current of the external input power. This ensures that the corresponding external input power meets the voltage threshold and current threshold required for driving the LED to operate, thereby entering an operation mode. In an example of the present disclosure, the bit period refers to the shortest time interval for completing the transmission or processing of one data bit (0 or 1), as shown in FIG. 8. Furthermore, in an example of the present disclosure, each LED power supply control apparatus can control one or more LEDs. When one LED power supply control apparatus controls a plurality of LEDs, the plurality of LEDs may be connected in series and/or parallel.

During the operation mode, each control module 15 continuously counts the bit periods of the received first control signal and generates the second control signal, to control the corresponding switch module 11 to actuate, thereby enabling the control module 15 to switch between different power supply modes. The power supply modes include power supply from the charging module 13 and power supply from the external input power. Both power supply modes, power supply from the charging module 13 and power supply from the external input power, can supply power to the LED, thereby ensuring normal operation of the LED. The counting of the bit periods of the first control signal is performed by the bit period counting module.

In an example of the present disclosure, the startup mode is defined as a state in which the external input power does not meet the voltage threshold or current threshold required for driving the LED to operate. Since the external input power cannot meet the voltage threshold or current threshold required for driving the LED to operate, the power received by the control module 15 is only sufficient to start the control module 15 but insufficient to drive the LED to operate. In an example of the present disclosure, the external input power may be, for example, an external power source or a carrier signal.

The operation mode is defined as a state in which the external input power meets the voltage threshold and current threshold required for driving the LED to operate, and the charging module 13 is activated. During the operation mode, the external input power not only meets the voltage threshold and current threshold required for driving the LED to operate, but can also activate the charging module 13 of the main power supply module 14 to charge the charging module 13.

In an example of the present disclosure, referring to FIG. 15, the main power supply module 14 further includes a power detection module. During the operation mode, the power detection module detects in real time whether the power of the charging module 13 meets the voltage threshold and current threshold required for driving the LED to operate. If it is detected that the power of the charging module 13 does not meet the voltage threshold or current threshold required for driving the LED to operate, the power detection module generates a third control signal. The third control signal is defined to control the switch module 11 to be in the online state, thereby charging the charging module 13.

In an example of the present disclosure, the third control signal has a higher priority than the second control signal, ensuring that the power of the charging module 13 meets the voltage threshold or current threshold required for driving the LED to operate. The presence of the third control signal enables the LED power supply control apparatus 1 to have a self-regulation function. After self-regulation is completed, the switch module 11 remains under the control of the second control signal.

In an example of the present disclosure, referring to FIG. 15, the main power supply module 14 further includes a voltage regulation module configured to perform voltage stabilization processing on the external input power.

In an example of the present disclosure, the LED power supply control apparatuses 1 are grouped into a plurality of groups. The control modules 15 in each group are preset with a same online bit period that differs from those of other groups. All the control modules 15 are preset with a same cyclic bit period.

In an example of the present disclosure, the cyclic bit period consists of a preset number of bit periods. A specific bit period within each cyclic bit period is used as an online bit period for the LED power supply control apparatus. When in the online bit period, the LED power supply control apparatus controls the switch module to be in the online state. As shown in Table 1, 12 LED power supply control apparatuses 1 are grouped into four groups. The online bit period of the first group is the first bit period in each cyclic bit period, the online bit period of the second group is the second bit period in each cyclic bit period, the online bit period of the third group is the third bit period in each cyclic bit period, and the online bit period of the fourth group is the fourth bit period in each cyclic bit period. The counted cyclic bit period is 4, meaning that when the bit period count reaches four, the bit period counting resets.

In an example of the present disclosure, each control module 15 generates the second control signal based on the counted bit periods, to control the corresponding switch modules 11 group-by-group to actuate. The implementation includes:

When the counted bit period matches the corresponding online bit period, the second control signal for controlling the switch module 11 to be in the online state. In this case, the corresponding LED power supply control apparatus 1 can receive the external input power. In an example of the present disclosure, the counted bit period refers to the current numerical value of the bit period obtained through counting.

When the counted bit period does not match the corresponding online bit period, the second control signal for controlling the switch module 11 to be in the offline state. In this case, the corresponding LED power supply control apparatus 1 cannot receive the external input power.

A detailed description is provided using the example shown in Table 1, in which 12 LED power supply control apparatuses are grouped into four groups.

| | First group | | Third group | Fourth group |
|---|---|---|---|---|
| | LED power supply | Second group | LED power | LED power |
| | control | LED power supply | supply control | supply control |
| | apparatuses i, v, | control apparatuses | apparatuses iii, | apparatuses iv, |
| | and ix | ii, vi, and x | vii, and xi | viii, and xii |
| Bit period | Online | Offline | Offline | Offline |
| 1 | | | | |
| Bit period | Offline | Online | Offline | Offline |
| 2 | | | | |
| Bit period | Offline | Offline | Online | Offline |
| 3 | | | | |
| Bit period | Offline | Offline | Offline | Online |
| 4 | | | | |

The cyclic bit period is 4. Every four bit periods, the operation states of the switch modules for all groups complete one cycle.

During the bit period 1, the switch modules 11 of the first group of LED power supply control apparatuses (i, v, and ix) are in the online state. The external input power supplies power to the first group of LED power supply control apparatuses (i, v, and ix), enabling the first group of LED power supply control apparatuses (i, v, and ix) to enter the operation mode. The switch modules 11 of the LED power supply control apparatuses in the other groups are in the offline state.

During the bit period 2, the switch modules 11 of the second group of LED power supply control apparatuses (ii, vi, and x) are in the online state. The external input power supplies power to the second group of LED power supply control apparatuses (ii, vi, and x), enabling the second group of LED power supply control apparatuses (ii, vi, and x) to enter the operation mode. The switch modules 11 of the LED power supply control apparatuses in the first, third, and fourth groups are in the offline state.

During the bit period 3, the switch modules 11 of the third group of LED power supply control apparatuses (iii, vii, and xi) are in the online state. The external input power supplies power to the third group of LED power supply control apparatuses (iii, vii, and xi), enabling the third group of LED power supply control apparatuses (iii, vii, and xi) to enter the operation mode. The switch modules 11 of the LED power supply control apparatuses in the first, second, and fourth groups are in the offline state.

During the bit period 4, the switch modules 11 of the fourth group of LED power supply control apparatuses (iv, viii, and xii) are in the online state. The external input power supplies power to the fourth group of LED power supply control apparatuses (iv, viii, and xii), enabling the fourth group of LED power supply control apparatuses (iv, viii, and xii) to enter the operation mode. The switch modules 11 of the LED power supply control apparatuses in the first, second, and third groups are in the offline state.

At this point, the LED power supply control apparatuses 1 enter the operation mode group-by-group. The LED power supply control apparatuses 1 may be connected in parallel or in series. However, regardless of whether a parallel or series connection is used, the method for the LED power supply control apparatuses 1 entering the operation mode group-by-group remains the same.

In an example of the present disclosure, when the LED power supply control apparatus 1 enters the operation mode, the control module 15 continuously and cyclically counts the bit periods of the first control signal, to continuously generate the second control signal and intermittently control the corresponding switch module 11 to actuate, enabling the corresponding control module 15 to switch between different power supply modes. The implementation includes:

Each control module controls, based on the second control signal, the switch module to switch between the online state and the offline state.

When the switch module 11 is in the online state, the external input power supplies power to the corresponding control module 15 and LED, and charges the charging module 13 in the corresponding main power supply module 14.

When the switch module 11 is in the offline state, the charging module 13 in the corresponding main power supply module 14 supplies power to the corresponding control module 15 and LED.

A detailed description is still provided using the example shown in Table 1, in which 12 LED power supply control apparatuses 1 are grouped into four groups. During the bit period 1, the switch modules 11 of the first group of LED power supply control apparatuses (i, v, and ix) are in the online state, and the external input power supplies power to the control modules 15 of the first group. The control modules 15 of the other groups are powered by the charging modules 13 in the main power supply modules 14, consuming no power from the external source, thereby achieving an energy-saving effect.

During the bit period 2, the switch modules 11 of the second group of LED power supply control apparatuses (ii, vi, and x) are in the online state, and the external input power supplies power to the control modules 15 of the second group. The control modules 15 of the other groups are powered by the charging modules 13 in the main power supply modules 14, consuming no power from the external source, thereby achieving an energy-saving effect.

During the bit period 3, the switch modules 11 of the third group of LED power supply control apparatuses (iii, vii, and xi) are in the online state, and the external input power supplies power to the control modules 15 of the third group. The control modules 15 of the other groups are powered by the charging modules 13 in the main power supply modules 14, consuming no power from the external source, thereby achieving an energy-saving effect.

During the bit period 4, the switch modules 11 of the fourth group of LED power supply control apparatuses (iv, viii, and xii) are in the online state, and the external input power supplies power to the control modules 15 of the fourth group. The control modules 15 of the other groups are powered by the charging modules 13 in the main power supply modules 14, consuming no power from the external source, thereby achieving an energy-saving effect.

The LED power supply control apparatuses 1 may be connected in parallel or in series. However, regardless of whether a parallel or series connection is used, the control method for the operation mode of the LED power supply control apparatuses remains the same.

In an example of the present disclosure, as shown in FIG. 1, the first control signal is an internal control signal. Correspondingly, a clock module and an address module are provided in the control module 15 to generate the internal control signal, as shown in FIG. 14. For example, software programming and burning are used to set the address for the control module 15 and generate the internal control signal. The address module is used to store the address, and the clock module ensures that the control module outputs a stable control signal (that is, the internal control signal).

In an example of the present disclosure, the first control signal is an external control signal. Correspondingly, the control module 15 further includes a decoding module and a driving module, as shown in FIG. 14. The decoding module is configured to decode the external control signal to obtain a decoded signal, and the driving module is configured to adjust the supply voltage based on the decoded signal to control the brightness of the LED. It should be noted that regardless of whether the power is supplied from the external input power or the charging module, the LED is driven via the driving module.

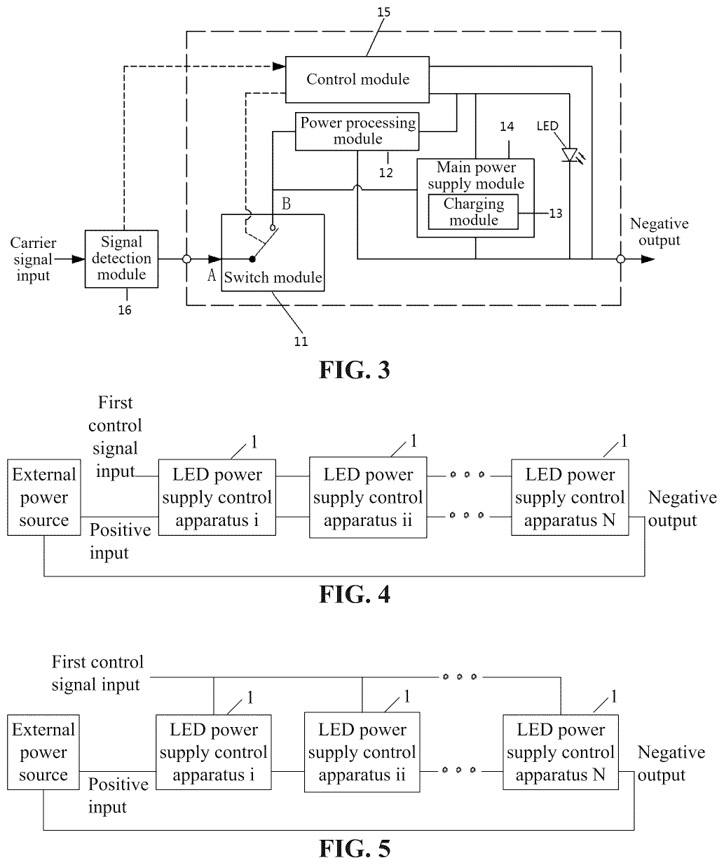

In an example of the present disclosure, the external control signal may be an independent signal. In this case, in addition to the positive and negative power lines, an independent signal line is required to transmit the control signal (that is, the independent signal), as shown in FIG. 2. Alternatively, a carrier signal may be used, as shown in FIG. 3. If an independent signal is used, the independent signal is input to the control module 15. After starting, the control module 15 decodes the first control signal (that is, the independent signal) from the external independent signal line and transmits decoded bit period data to a bit period counting module for processing.

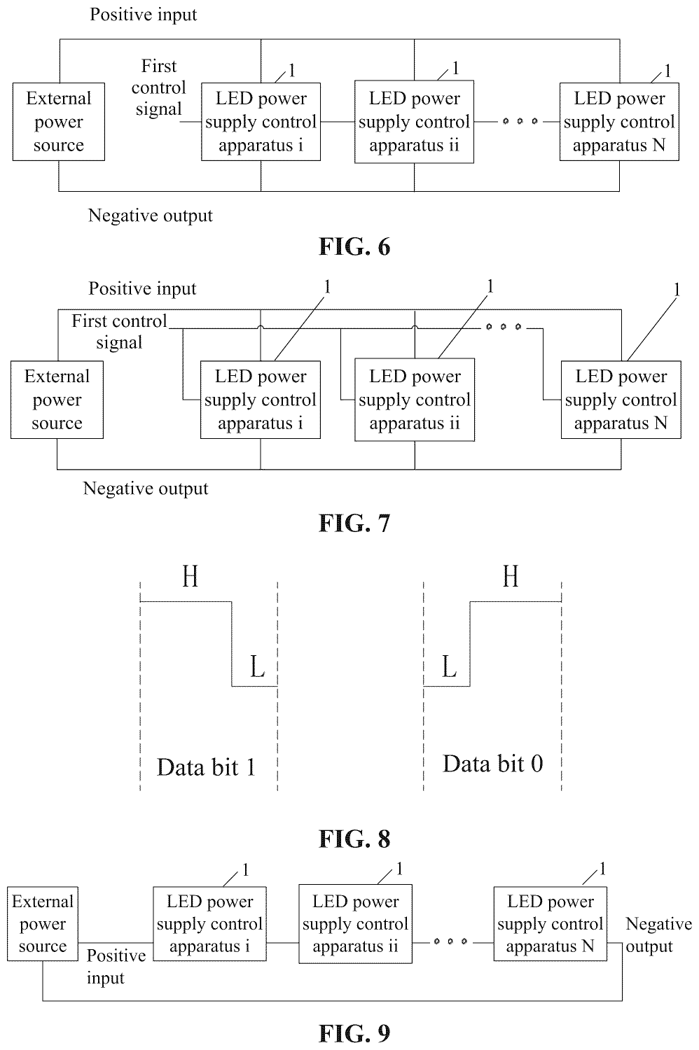

The plurality of LED power supply control apparatuses 1 may be connected in parallel or in series, and the external control signals in the form of the independent signals may also be connected in parallel or in series. Thus, the LED power supply control apparatuses 1 and the independent external control signal form four different connection modes. FIG. 4 shows an LED power supply control system in which the LED power supply control apparatuses 1 are connected in series and the first control signal is a series-independent signal. FIG. 5 shows an LED power supply control system in which the LED power supply control apparatuses 1 are connected in series and the first control signal is a parallel-independent signal. FIG. 6 shows an LED power supply control system in which the LED power supply control apparatuses 1 are connected in parallel and the first control signal is a series-independent signal. FIG. 7 is a schematic structural diagram of an LED power supply control system in which the LED power supply control apparatuses 1 are connected in parallel and the first control signal is a parallel-independent signal.

As shown in FIG. 3, if a carrier signal is adopted, the carrier signal is obtained by merging the external input power and the control signal. Correspondingly, the LED power supply control apparatus further includes a signal detection module 16 configured to receive and detect the carrier signal. The detected power signal is input as the external input power to the switch module 11, and a detected high/low level digital signal is demodulated and used as the first control signal for decoding. Decoded bit period data is then transmitted to the bit period counting module.

The signal detection module 16 can detect data of the carrier signal by means of voltage comparison. For example, a reference voltage is set in advance. When the signal detection module 16 detects a signal higher than the reference voltage, the signal is determined as a high level; or when detects a signal lower than the reference voltage, the signal is determined as a low level. Demodulation of the high/low levels yields the external input power and the first control signal.

Since the carrier signal composed of the high/low level needs to provide both power supply and the first control signal to the LED power supply control apparatus 1, the carrier signal needs to satisfy the following characteristics: The data bit 0 and data bit 1 have the same duration, and the data bit 0 and data bit 1 have the same high-level duration, as shown in FIG. 8. The same high-level duration ensures that when the LED power supply control apparatus 1 is in the online bit period, sufficient power can be provided to the LED and the charging module 13.

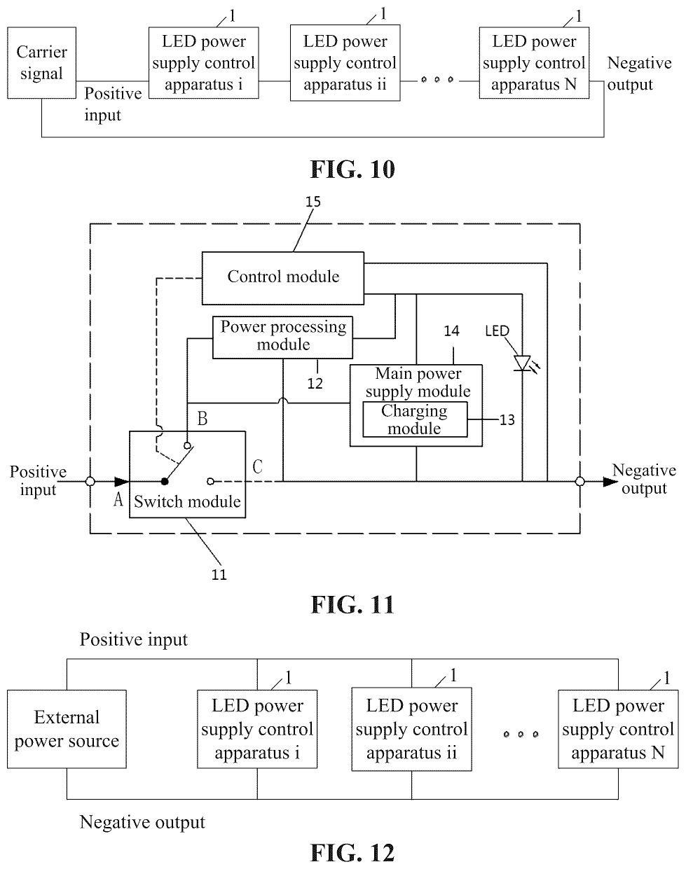

Based on the characteristics of the LED power supply control apparatus 1 in the LED power supply control system provided in the present disclosure, an example of the present disclosure provides an LED power supply control system in which the LED power supply control apparatuses 1 are connected in series and the first control signal is an internal control signal, as shown in FIG. 9. An example of the present disclosure further provides an LED power supply control system in which the LED power supply control apparatuses are connected in series and the first control signal is an external control signal in the form of a series-independent signal, as shown in FIG. 4. An example of the present disclosure further provides an LED power supply control system in which the LED power supply control apparatuses are connected in series and the first control signal is an external control signal in the form of a carrier signal, as shown in FIG. 10. In the LED power supply control system in which the LED power supply control apparatuses are connected in series, the corresponding switch module 11 further includes a third contact C, as shown in FIG. 11. The third contact C of the switch module is connected to the second output terminal of the power processing module 12, the second output terminal of the main power supply module 14, and the negative pole of the external input power. When the switch module 11 is in the offline state, the first contact A of the switch module is connected to the third contact C, ensuring that the entire LED power supply control system remains in a connected state.

In an example of the present disclosure, if the LED power supply control apparatuses 1 are connected in series, the quantity of LED power supply control apparatuses 1 in each group is calculated using a first formula.

The first formula is:

$$N \leq \frac{V}{{V}_{q}} .$$

N represents the quantity of LED power supply control apparatuses in each group, V represents the voltage of the external input power, and V_{q} represents the voltage threshold.

The quantity of LED power supply control apparatuses in each group, as determined through the first formula, ensures that the voltage of the external input power can meet the voltage requirements of the LED power supply control apparatuses 1 of which the switch modules 11 are in the online state during each bit period.

In an example of the present disclosure, for the LED power supply control system in which the LED power supply control apparatuses 1 are connected in series, the received external input power is processed through the corresponding power processing module. The implementation includes:
performing a boost conversion on the external input power through the corresponding power processing module.

Take 12 LED power supply control apparatuses 1 connected in series as an example for description. The grouping and online bit period settings still follow the example shown in Table 1, in which the 12 LED power supply control apparatuses 1 are grouped into four groups. In this case, the voltage of the external input power is 12 V, the startup voltage of the control module 15 is 1.8 V, and the voltage threshold required for driving the LED is 3 V. The specific control process for the corresponding LED power supply control apparatuses 1 is as follows:

The LED power supply control apparatuses 1 receive the external input power and are powered on. In this case, all the switch modules 11 are in the online state, with the first contact A connected to the second contact B of each switch module. The external input power is distributed equally among the 12 LED power supply control apparatuses 1. The voltage at the positive input terminal of each LED power supply control apparatus 1 is 1 V. That is, the external input power does not meet the voltage threshold required for driving the LED, and can only serve as the startup voltage for the control module 15.

Furthermore, the corresponding external input power is processed by the power processing module 12, to boost the voltage from 1 V to 1.8 V. The processed 1.8 V voltage is then used to start the control module 15. In this case, the power obtained by the control module 15 only reaches the startup voltage of the control module 15. Thus, the control module 15 is activated, but the LED is not driven.

After startup, the control module 15 counts the bit periods of the received first control signal according to a pre-configured bit period counting instruction and generates the second control signal.

Specifically, during the bit period 1, the second control signal generated by the LED power supply control apparatuses 1 in the first group is: controlling the switch module 11 to be in the online state; and the second control signal generated by the LED power supply control apparatuses 1 in the second, third, and fourth groups is: controlling the switch module 11 to be in the offline state. In this case, only three LED power supply control apparatuses 1 in the first group receive the external input power. The voltage of the external input power received by each of the LED power supply control apparatuses 1 reaches 4 V, which meets the voltage threshold required for driving the LED to operate. The 4 V voltage is transmitted to the main power supply module 14 and the control module 15, driving the LED to operate while charging the charging module 13 in the main power supply module 14, thereby entering the operation mode. The main power supply module further includes a built-in voltage regulation module, which steps down the 4 V to 3 V to drive the control module and the LED to operate.

During the bit period 2, the second control signal generated by the LED power supply control apparatuses 1 in the second group is: controlling the switch module 11 to be in the online state; and the second control signal generated by the LED power supply control apparatuses 1 in the first, third, and fourth groups is: controlling the switch module 11 to be in the offline state. The LED power supply control apparatuses 1 in the second group use the external input power to drive the LEDs to operate and charge the charging modules 13 in corresponding main power supply modules 14, thereby entering the operation mode. Meanwhile, the LED power supply control apparatuses 1 in the first group are powered by the charging modules 13 in the main power supply modules 14.

During the bit period 3, the second control signal generated by the LED power supply control apparatuses 1 in the third group is: controlling the switch module 11 to be in the online state; and the second control signal generated by the LED power supply control apparatuses 1 in the first, second, and fourth groups is: controlling the switch module 11 to be in the offline state. The LED power supply control apparatuses 1 in the third group use the external input power to drive the LEDs to operate and charge the charging modules 13 in the main power supply modules 14, thereby entering the operation mode. Meanwhile, the LED power supply control apparatuses 1 in the first and second groups are powered by the charging modules 13 in the main power supply modules 14.

During the bit period 4, the second control signal generated by the LED power supply control apparatuses 1 in the fourth group is: controlling the switch module 11 to be in the online state; and the second control signal generated by the LED power supply control apparatuses 1 in the first, second, and third groups is: controlling the switch module 11 to be in the offline state. The LED power supply control apparatuses 1 in the fourth group use the external input power to drive the LEDs to operate and charge the charging modules 13 in the main power supply modules 14, thereby entering the operation mode. Meanwhile, the LED power supply control apparatuses in the first, second, and third groups are powered by the charging modules 13 in the main power supply modules 14.

After the LED power supply control apparatuses 1 enter the operation mode, the cycle of bit periods described above continues. Each control module 15, based on the bit period, controls the corresponding switch module 11 to actuate. When the switch module 11 is in the online state, the control module 15 is powered by the external input power. When the switch module 11 is in the offline state, the control module 15 is powered by the main power supply module 14. This enables the control module 15 to switch between power supply from the external input power and power supply from the charging module 13 in the main power supply module 14. When powered by the charging module 13 in the main power supply module 14, no external input power is consumed.

In the examples of the present disclosure, a 12 V voltage is used to drive 12 LEDs, each with a 3 V voltage threshold, thereby achieving an energy-saving effect.

In the examples of the present disclosure, at any given time, only one group including three LED power supply control apparatuses is in the online bit period and requires power supply from the external input power. The remaining nine LED power supply control apparatuses 1 are powered by the charging modules 13. This allows a 12 V voltage to drive the 12 LEDs, each with a 3 V voltage threshold. In contrast, in a traditional LED power supply operation mode, each LED power supply control apparatus requires the same voltage to be supplied externally, necessitating a 36 V external voltage for the 12 LED power supply control apparatuses. Therefore, the LED power supply control system provided in the examples of the present disclosure is more energy-efficient than the traditional LED power supply operation mode and offers a more diversified control method.

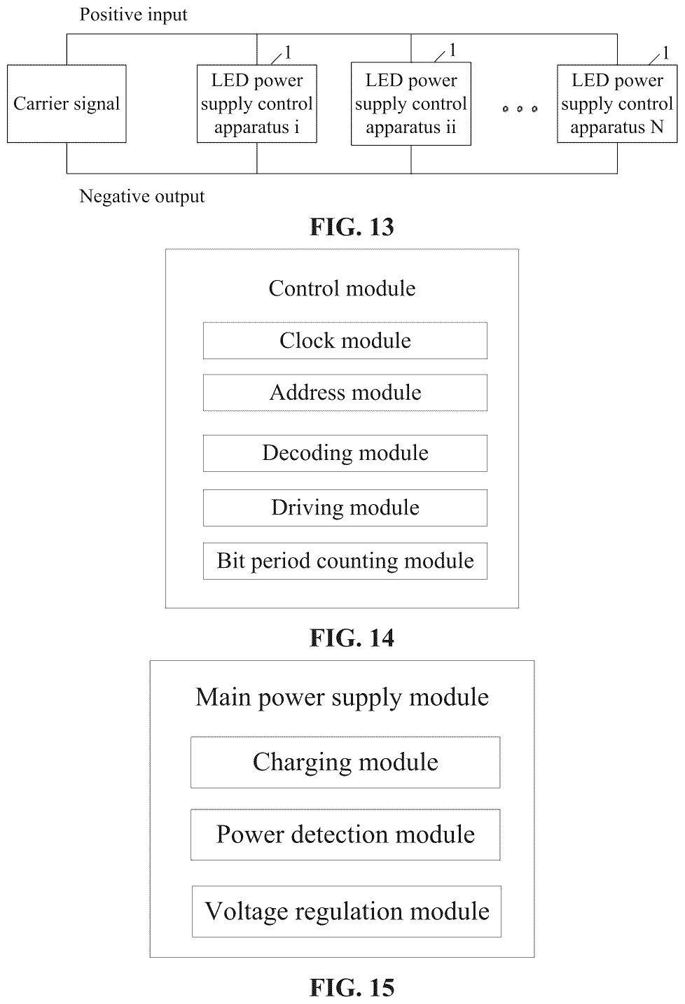

In an example of the present disclosure, based on the characteristics of the LED power supply control apparatuses 1 in the LED power supply control system, the LED power supply control apparatuses are connected in parallel. Specifically, an example of the present disclosure provides an LED power supply control system in which the LED power supply control apparatuses are connected in parallel and the first control signal is an internal control signal, as shown in FIG. 12. An example of the present disclosure further provides an LED power supply control system in which the LED power supply control apparatuses are connected in parallel and the first control signal is an external control signal in the form of a series-independent signal, as shown in FIG. 6. An example of the present disclosure further provides an LED power supply control system in which the LED power supply control apparatuses are connected in parallel and the first control signal is an external control signal in the form of a carrier signal, as shown in FIG. 13.

The quantity of LED power supply control apparatuses in each group is calculated using a second formula.

The second formula is:

$$N \leq \frac{I}{{I}_{q}} .$$

N represents the quantity of LED power supply control apparatuses in each group, I represents the current of the external input power, and I_{q} represents the current threshold.

The quantity of LED power supply control apparatuses 1 in each group, as determined through the second formula, ensures that the current of the external input power can meet the current requirements of the LED power supply control apparatuses 1 of which the switch modules 11 are in the online state during each bit period.

In an example of the present disclosure, for the LED power supply control system in which the LED power supply control apparatuses 1 are connected in parallel, the received external input power is processed through the corresponding power processing module. The implementation includes:
performing a buck conversion on the external input power through the corresponding power processing module.

A specific description is provided using an example of 12 LED power supply control apparatuses connected in parallel. In this example, the external input power has a voltage of 12 V and a current of 24 mA; the control module 15 has an operation voltage of 3 V and an operation current of 2 mA; and the voltage threshold required for driving the LED is 3 V, and the current threshold is 10 mA. Therefore, according to the second formula, the quantity of LED power supply control apparatuses 1 in each group is determined as 2, allowing grouping into 6 groups. The grouping and online bit period settings for the LED power supply control apparatuses 1 are shown in Table 2 below.

| | First | Second | Third | Fourth | Fifth | Sixth |
|---|---|---|---|---|---|---|
| | group | group | group | group | group | group |
| | LED | LED | LED | LED | LED | LED |
| | power | power | power | power | power | power |
| | supply | supply | supply | supply | supply | supply |
| | control | control | control | control | control | control |
| | apparatuses | apparatuses | apparatuses | apparatuses | apparatuses | apparatuses |
| | i and vii | ii and viii | iii and ix | iv and x | v and xi | vi and xii |
| Bit period 1 | Online | Offline | Offline | Offline | Offline | Offline |
| Bit period 2 | Offline | Online | Offline | Offline | Offline | Offline |
| Bit period 3 | Offline | Offline | Online | Offline | Offline | Offline |
| Bit period 4 | Offline | Offline | Offline | Online | Offline | Offline |
| Bit period 5 | Offline | Offline | Offline | Offline | Online | Offline |
| Bit period 6 | Offline | Offline | Offline | Offline | Offline | Online |

The cyclic bit period is 6. Every six bit periods, the operation states of the switch modules for all groups complete one cycle.

The specific control process for the corresponding LED power supply control apparatuses is as follows:

The LED power supply control apparatuses 1 receive the external input power and are powered on. In this case, all switch modules 11 are in the online state, with the first contact A connected to the second contact B of each switch module. The current of the external input power is distributed equally among the 12 LED power supply control apparatuses 1. The current at the positive input terminal of each LED power supply control apparatus 1 is 2 mA, while the voltage is 12 V. That is, the external input power does not meet the current threshold required for driving the LED.

Furthermore, the corresponding external input power undergoes a buck conversion by the power processing module 12, reducing the 12 V/2 mA external input power to 3 V/2 mA. The processed 3 V/2 mA power is then used to start the control module 15. In this case, the power obtained by the control module 15 only reaches the startup voltage of the control module 15. Thus, the control module 15 is activated, but the LED is not driven.

After startup, the control module 15 counts the bit periods of the received first control signal according to a pre-configured bit period counting instruction and generates the second control signal.

Specifically, during the bit period 1, the second control signal generated by the LED power supply control apparatuses 1 in the first group is: controlling the switch module 11 to be in the online state; and the second control signal generated by the LED power supply control apparatuses 1 in the second, third, fourth, fifth, and sixth groups is: controlling the switch module 11 to be in the offline state. In this case, only two LED power supply control apparatuses 1 in the first group receive the external input power. The current of the external input power received by each of the LED power supply control apparatuses 1 reaches 12 mA, which meets the current threshold required for driving the LED. This external input power is transmitted to the main power supply module 14 and the control module 15, driving the LED to operate while charging the charging module 13 in the main power supply module 14, thereby entering the operation mode.

During the bit period 2, the second control signal generated by the LED power supply control apparatuses 1 in the second group is: controlling the switch module 11 to be in the online state; and the second control signal generated by the LED power supply control apparatuses 1 in the first, third, fourth, fifth, and sixth groups is: controlling the switch module 11 to be in the offline state. The LED power supply control apparatuses 1 in the second group use the external input power to drive the LEDs and charge the charging modules 13 in the main power supply modules 14, thereby entering the operation mode. Meanwhile, the LED power supply control apparatuses 1 in the first group are powered by the charging modules 13 in the main power supply modules 14.

During the bit period 3, the second control signal generated by the LED power supply control apparatuses 1 in the third group is: controlling the switch module 11 to be in the online state; and the second control signal generated by the LED power supply control apparatuses 1 in the first, second, fourth, fifth, and sixth groups is: controlling the switch module 11 to be in the offline state. The LED power supply control apparatuses 1 in the third group use the external input power to drive the LEDs and charge the charging modules 13 in the main power supply modules 14, thereby entering the operation mode. Meanwhile, the LED power supply control apparatuses 1 in the first and second groups are powered by the charging modules 13 in the main power supply modules 14.

During the bit period 4, the second control signal generated by the LED power supply control apparatuses 1 in the fourth group is: controlling the switch module 11 to be in the online state; and the second control signal generated by the LED power supply control apparatuses 1 in the first, second, third, fifth, and sixth groups is: controlling the switch module 11 to be in the offline state. The LED power supply control apparatuses 1 in the fourth group use the external input power to drive the LEDs and charge the charging modules 13 in the main power supply modules 14, thereby entering the operation mode. Meanwhile, the LED power supply control apparatuses 1 in the first, second, and third groups are powered by the charging modules 13 in the main power supply modules 14.

During the bit period 5, the second control signal generated by the LED power supply control apparatuses 1 in the fifth group is: controlling the switch module 11 to be in the online state; and the second control signal generated by the LED power supply control apparatuses 1 in the first, second, third, fourth, and sixth groups is: controlling the switch module 11 to be in the offline state. The LED power supply control apparatuses 1 in the fifth group use the external input power to drive the LEDs and charge the charging modules 13 in the main power supply modules 14, thereby entering the operation mode. Meanwhile, the LED power supply control apparatuses 1 in the first, second, third, and fourth groups are powered by the charging modules 13 in the main power supply modules 14.

During the bit period 6, the second control signal generated by the LED power supply control apparatuses 1 in the sixth group is: controlling the switch module 11 to be in the online state; and the second control signal generated by the LED power supply control apparatuses 1 in the first, second, third, fourth, and fifth groups is: controlling the switch module 11 to be in the offline state. The LED power supply control apparatuses 1 in the sixth group use the external input power to drive the LEDs and charge the charging modules 13 in the main power supply modules 14, thereby entering the operation mode. Meanwhile, the LED power supply control apparatuses 1 in the first, second, third, fourth, and fifth groups are powered by the charging modules 13 in the main power supply modules 14.

After the LED power supply control apparatuses 1 enter the operation mode, the cycle of bit periods described above continues. Each control module 15, based on the bit period, controls the corresponding switch module 11 to actuate. When the switch module 11 is in the online state, the control module 15 is powered by the external input power. When the switch module 11 is in the offline state, the control module 15 is powered by the charging module 13 in the main power supply module 14. This enables the control module 15 to switch between power supply from the external input power and power supply from the main power supply module 14. When powered by the charging module 13 in the main power supply module 14, no external input power is consumed.

In the examples of the present disclosure, at any given time, only one group including two LED power supply control apparatuses 1 is in the online bit period and requires power supply from the external input power. The remaining 10 LED power supply control apparatuses 1 are powered by the charging modules 13. The total power consumption of the entire LED power supply control system is 12V/24 mA, enabling the operation of 12 LEDs, each requiring 10 mA, with a 24 mA current. In contrast, in a traditional LED power supply operation mode, each LED power supply control apparatus 1 requires the same current to be supplied externally, necessitating a 120 mA external current for the 12 LED power supply control apparatuses 1. Therefore, the LED power supply control system provided in the present disclosure is more energy-efficient than the traditional LED power supply operation mode and offers a more diversified control method.

In an example of the present disclosure, the switch module 11, the power processing module 12, the main power supply module 14, the control module 15, the charging module 13, the power detection module, the decoding module, the driving module, the bit period counting module, the voltage regulation module, the clock module, the address module, and the signal detection module 16 each may be one or more processors, controllers or chips that each have a communication interface, can realize a communication protocol, and may further include a memory, a related interface and system transmission bus, and the like if necessary. The processor, controller or chip executes program-related code to realize a corresponding function.

In the examples of the present disclosure, by grouping the LED power supply control apparatuses 1 and configuring each group with the same cyclic bit period and the same online bit period that differs from that of other groups, alternating control of the switch modules 11 is achieved during both the startup mode and the operation mode. This enables the LED control modules 15 to switch between power supply from the external input power and power supply from the charging modules 13. In each bit period, only a portion of the LED power supply control apparatuses 1 consumes the external input power, thereby reducing the power consumption, improving energy utilization efficiency, and enabling a greater number of LEDs to be powered at the same voltage. Through the configuration of the switch module 11, power processing module 12, main power supply module 14, and control module 15, switching between a plurality of operation modes and control methods is realized, making the system adaptable to various application scenarios.

The above examples are only intended to illustrate several implementations of the present disclosure in detail, and they should not be construed as a limitation to the patentable scope of the present disclosure. It should be noted that those of ordinary skill in the art can further make variations and improvements without departing from the conception of the present disclosure. These variations and improvements all fall within the protection scope of the present disclosure. Therefore, the protection scope of the present disclosure should be subject to the protection scope defined by the claims.

1. An LED power supply control system, comprising: a plurality of LED power supply control apparatuses, wherein each of the LED power supply control apparatuses comprises a switch module, a power processing module, a main power supply module, and a control module; the main power supply module comprises a charging module; and
each of the LED power supply control apparatuses is configured to:
during a startup mode, control the corresponding switch module to be in an online state, process received external input power through the corresponding power processing module, and use the processed external input power to supply power to the corresponding control module, to start the corresponding control module;
count, through the started control module, bit periods of a first control signal received by the respective control module, and generate, through the respective control module based on the counted bit periods, a second control signal for enabling control of the corresponding switch modules group-by-group to actuate, such that the corresponding external input power meets a voltage threshold and a current threshold required for driving an LED to operate, thereby entering an operation mode; and
during the operation mode, control, through the respective control module and based on the second control signal, the corresponding switch module to actuate, such that the corresponding control module switches between different power supply modes, wherein the power supply modes comprise power supply from the charging module and power supply from the external input power.

2. The LED power supply control system according to claim 1, wherein the startup mode occurs on condition that the external input power does not meet the voltage threshold or the current threshold required for driving the LED to operate; and
the operation mode occurs on condition that the external input power meets the voltage threshold and the current threshold required for driving the LED to operate, and the charging module is activated and charged.

3. The LED power supply control system according to claim 1, wherein the main power supply module further comprises a power detection module configured to:
during the operation mode, detect whether power of the charging module meets the voltage threshold and the current threshold required for driving the LED to operate; and
determining that the power of the charging module that is detected during the operation mode does not meet the voltage threshold and the current threshold required for driving the LED to operate, generate a third control signal to control the switch module to be in the online state, wherein
the third control signal has a higher priority than the second control signal.

4. The LED power supply control system according to claim 1, wherein the control module comprises a positive connection terminal, a negative connection terminal, and a control signal output terminal; in each of the LED power supply control apparatuses, a first contact of the switch module is connected to a positive pole of the external input power, and a second contact of the switch module is connected to an input terminal of the power processing module and an input terminal of the main power supply module, respectively; a first output terminal of the main power supply module and a first output terminal of the power processing module are both connected to the positive connection terminal of the control module;
a second output terminal of the main power supply module, a second output terminal of the power processing module, and the negative connection terminal of the control module are all connected to a negative pole of the external input power;
the positive connection terminal of the control module is further configured to be connected to a positive pole of the LED, and the negative pole of the external input power is further connected to a negative pole of the LED; and
the control signal output terminal of the control module is connected to a controlled terminal of the switch module.

5. The LED power supply control system according to claim 1, wherein the first control signal is an internal control signal.

6. The LED power supply control system according to claim 1, wherein the first control signal is an external control signal;
the corresponding control module further comprises a decoding module and a driving module;
the decoding module is configured to decode the external control signal to obtain bit period data; and
the driving module is configured to drive the LED to operate.

7. The LED power supply control system according to claim 6, wherein the external control signal is transmitted in a form of an independent signal or a carrier signal;
the carrier signal is a signal transmitted based on the external input power; and
a data bit 0 and a data bit 1 corresponding to the carrier signal have same duration, and the data bit 0 and the data bit 1 have same high-level duration.

8. The LED power supply control system according to claim 1, wherein the LED power supply control apparatuses are grouped into a plurality of groups, and the control modules in each group are preset with a same online bit period that differs from online bit periods of other groups;
wherein, generate, through the respective control module based on the counted bit periods, the second control signal for enabling control of the corresponding switch modules group-by-group to actuate, comprises that each of the LED power supply control apparatuses is configured to:
on condition that the counted bit period matches the corresponding online bit period, generate, through the respective control module, the second control signal for controlling the switch module to be in the online state; or
on condition that the counted bit period does not match the corresponding online bit period, generate, through the respective control module, the second control signal for controlling the switch module to be in an offline state, wherein on condition that the switch module is in the offline state, the corresponding LED power supply control apparatus is unable to receive the external input power; and
wherein, control, through the respective control module and based on the second control signal, the corresponding switch module to actuate, such that the corresponding control module switches between different power supply modes, comprises that each of the LED power supply control apparatuses is configured to:
control, through the respective control module and based on the second control signal, the switch module to switch between the online state and the offline state, wherein
on condition that the switch module is in the online state, the external input power supplies power to the corresponding control module and the LED and charges the corresponding charging module; or
on condition that the switch module is in the offline state, the corresponding charging module supplies power to the corresponding control module and the LED.

9. The LED power supply control system according to claim 1, wherein the LED power supply control apparatuses are grouped into a plurality of groups, and the control modules in each of the groups are preset with a same online bit period that differs from online bit periods of other groups; the LED power supply control apparatuses are connected in series, the corresponding switch module comprises a first contact, a second contact, and a third contact, the first contact of the switch module is connected to a positive pole of the external input power, and the second contact of the switch module is connected to an input terminal of the power processing module and an input terminal of the main power supply module, respectively; and the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and V_{q} represents the voltage threshold; and
wherein, process the received external input power through the corresponding power processing module, comprises that each of the LED power supply control apparatuses is configured to:
perform a boost conversion on the received external input power through the corresponding power processing module.

10. The LED power supply control system according to claim 2, wherein the LED power supply control apparatuses are grouped into a plurality of groups, and the control modules in each of the groups are preset with a same online bit period that differs from online bit periods of other groups; the LED power supply control apparatuses are connected in series, the corresponding switch module comprises a first contact, a second contact, and a third contact, the first contact of the switch module is connected to a positive pole of the external input power, and the second contact of the switch module is connected to an input terminal of the power processing module and an input terminal of the main power supply module, respectively; and the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and V_{q} represents the voltage threshold; and
wherein, process the received external input power through the corresponding power processing module, comprises that each of the LED power supply control apparatuses is configured to:
perform a boost conversion on the received external input power through the corresponding power processing module.

11. The LED power supply control system according to claim 3, wherein the LED power supply control apparatuses are grouped into a plurality of groups, and the control modules in each of the groups are preset with a same online bit period that differs from online bit periods of other groups; the LED power supply control apparatuses are connected in series, the corresponding switch module comprises a first contact, a second contact, and a third contact, the first contact of the switch module is connected to a positive pole of the external input power, and the second contact of the switch module is connected to an input terminal of the power processing module and an input terminal of the main power supply module, respectively; and the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and Va represents the voltage threshold; and
wherein, process the received external input power through the corresponding power processing module, comprises that each of the LED power supply control apparatuses is configured to:
perform a boost conversion on the received external input power through the corresponding power processing module.

12. The LED power supply control system according to claim 4, wherein the LED power supply control apparatuses are grouped into a plurality of groups, and the control modules in each of the groups are preset with a same online bit period that differs from online bit periods of other groups; the LED power supply control apparatuses are connected in series, the corresponding switch module further comprises a third contact, the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and V_{q} represents the voltage threshold; and
wherein, process the received external input power through the corresponding power processing module, comprises that each of the LED power supply control apparatuses is configured to:
perform a boost conversion on the received external input power through the corresponding power processing module.

13. The LED power supply control system according to claim 5, wherein the LED power supply control apparatuses are grouped into a plurality of groups, and the control modules in each of the groups are preset with a same online bit period that differs from online bit periods of other groups; the LED power supply control apparatuses are connected in series, the corresponding switch module comprises a first contact, a second contact, and a third contact, the first contact of the switch module is connected to a positive pole of the external input power, and the second contact of the switch module is connected to an input terminal of the power processing module and an input terminal of the main power supply module, respectively; and the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and V_{q} represents the voltage threshold; and
wherein, process the received external input power through the corresponding power processing module, comprises that each of the LED power supply control apparatuses is configured to:
perform a boost conversion on the received external input power through the corresponding power processing module.

14. The LED power supply control system according to claim 6, wherein the LED power supply control apparatuses are grouped into a plurality of groups, and the control modules in each of the groups are preset with a same online bit period that differs from online bit periods of other groups; the LED power supply control apparatuses are connected in series, the corresponding switch module comprises a first contact, a second contact, and a third contact, the first contact of the switch module is connected to a positive pole of the external input power, and the second contact of the switch module is connected to an input terminal of the power processing module and an input terminal of the main power supply module, respectively; and the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and V_{q} represents the voltage threshold; and
wherein, process the received external input power through the corresponding power processing module, comprises that each of the LED power supply control apparatuses is configured to:
perform a boost conversion on the received external input power through the corresponding power processing module.

15. The LED power supply control system according to claim 7, wherein the LED power supply control apparatuses are grouped into a plurality of groups, and the control modules in each of the groups are preset with a same online bit period that differs from online bit periods of other groups; the LED power supply control apparatuses are connected in series, the corresponding switch module comprises a first contact, a second contact, and a third contact, the first contact of the switch module is connected to a positive pole of the external input power, and the second contact of the switch module is connected to an input terminal of the power processing module and an input terminal of the main power supply module, respectively; and the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and V_{q} represents the voltage threshold; and
wherein, process the received external input power through the corresponding power processing module, comprises that each of the LED power supply control apparatuses is configured to:
perform a boost conversion on the received external input power through the corresponding power processing module.

16. The LED power supply control system according to claim 8, wherein the LED power supply control apparatuses are connected in series, the corresponding switch module comprises a first contact, a second contact, and a third contact, the first contact of the switch module is connected to a positive pole of the external input power, and the second contact of the switch module is connected to an input terminal of the power processing module and an input terminal of the main power supply module, respectively; and the third contact is connected to a second output terminal of the power processing module, a second output terminal of the main power supply module, and a negative pole of the external input power;
on condition that the switch module is in an offline state, the corresponding first contact is connected to the third contact;
a quantity of LED power supply control apparatuses in each of the groups is calculated by using a first formula; and
the first formula is:
$$N \leq \frac{V}{{V}_{q}} ,$$
wherein
N represents the quantity of LED power supply control apparatuses in each of the groups, V represents a voltage of the external input power, and V_{q} represents the voltage threshold; and
wherein, process the received external input power through the corresponding power processing module, comprises that each of the LED power supply control apparatuses is configured to:
perform a boost conversion on the received external input power through the corresponding power processing module.

17. The LED power supply control system according to claim 1, wherein the LED power supply control apparatuses are grouped into a plurality of groups, and the control modules in each of the groups are preset with a same online bit period that differs from online bit periods of other groups; the LED power supply control apparatuses are connected in parallel;
a quantity of LED power supply control apparatuses in each of the groups is calculated by using a second formula; and
the second formula is:
$$N \leq \frac{I}{{I}_{q}} ,$$
wherein
N represents the quantity of LED power supply control apparatuses in each of the groups, I represents a current of the external input power, and I_{q} represents the current threshold; and
wherein, process the received external input power through the corresponding power processing module, comprises that each of the LED power supply control apparatuses is configured to:
perform a buck conversion on the received external input power through the corresponding power processing module.

18. The LED power supply control system according to claim 2, wherein the LED power supply control apparatuses are grouped into a plurality of groups, and the control modules in each of the groups are preset with a same online bit period that differs from online bit periods of other groups; the LED power supply control apparatuses are connected in parallel;
a quantity of LED power supply control apparatuses in each of the groups is calculated by using a second formula; and
the second formula is:
$$N \leq \frac{I}{{I}_{q}} ,$$
wherein
N represents the quantity of LED power supply control apparatuses in each of the groups, I represents a current of the external input power, and I_{q} represents the current threshold; and
wherein, process the received external input power through the corresponding power processing module, comprises that each of the LED power supply control apparatuses is configured to:
perform a buck conversion on the received external input power through the corresponding power processing module.

19. The LED power supply control system according to claim 3, wherein the LED power supply control apparatuses are grouped into a plurality of groups, and the control modules in each of the groups are preset with a same online bit period that differs from online bit periods of other groups; the LED power supply control apparatuses are connected in parallel;
a quantity of LED power supply control apparatuses in each of the groups is calculated by using a second formula; and
the second formula is:
$$N \leq \frac{I}{{I}_{q}} ,$$
wherein
N represents the quantity of LED power supply control apparatuses in each of the groups, I represents a current of the external input power, and I_{q} represents the current threshold; and
wherein, process the received external input power through the corresponding power processing module, comprises that each of the LED power supply control apparatuses is configured to:
perform a buck conversion on the received external input power through the corresponding power processing module.

20. The LED power supply control system according to claim 4, wherein the LED power supply control apparatuses are grouped into a plurality of groups, and the control modules in each of the groups are preset with a same online bit period that differs from online bit periods of other groups; the LED power supply control apparatuses are connected in parallel;
a quantity of LED power supply control apparatuses in each of the groups is calculated by using a second formula; and
the second formula is:
$$N \leq \frac{I}{{I}_{q}} ,$$
wherein
N represents the quantity of LED power supply control apparatuses in each of the groups, I represents a current of the external input power, and I_{q} represents the current threshold; and
wherein, process the received external input power through the corresponding power processing module, comprises that each of the LED power supply control apparatuses is configured to:
perform a buck conversion on the received external input power through the corresponding power processing module.
